(19) United States
(12) Patent Application Publication
(10) Pub. No.: US 2016/0172784 A1
(43) Pub. Date: Jun. 16, 2016

(54) CONNECTOR

(71) Applicant: YAZAKI CORPORATION, Tokyo (JP)

(72) Inventors: Masayuki KATAOKA, Shizuoka (JP); Fuminori SUGIYAMA, Shizuoka (JP)

(73) Assignee: YAZAKI CORPORATION, Tokyo (JP)

(21) Appl. No.: 15/051,703

(22) Filed: Feb. 24, 2016

Related U.S. Application Data
(63) Continuation of application No. PCT/JP2014/073339, filed on Sep. 4, 2014.

(30) Foreign Application Priority Data
Sep. 6, 2013 (JP) 2013-185150

(51) Int. Cl. H01R 13/52

(52) U.S. Cl. CPC H01R 13/5202; H01R 13/5221

(57) ABSTRACT

A high-pressure connector (1) provided with an integrated housing (41) that supports a terminal (21), and a sealing portion (46) that seals a space between the integrated housing (41) and a device case (50). The sealing portion (46) is formed of a water-swellable sealing material provided on a face of the integrated housing (41) opposing the device case (50).

### CROSS REFERENCE TO RELATED APPLICATIONS

This application is a Continuation of PCT Application No. PCT/JP2014/073339, filed on Sep. 4, 2014, and claims the priority of Japanese Patent Application No. 2013-185150, filed on Sep. 6, 2013, the content of both of which is incorporated herein by reference.

### BACKGROUND

1. Technical Field

The present invention relates to a waterproof connector.

2. Related Art

Conventionally, various waterproof connectors have been proposed (see JP 2012-151067 A). An example of such conventional connectors is illustrated in FIGS. 1A and 1B. As illustrated in FIGS. 1A and 1B, the connector 100 includes a terminal 101 connected to a wire W, a housing 110, and a shield shell 120. The terminal 101 is partially housed in a terminal accommodating chamber 111 of the housing 110 with the distal end portion of the terminal 101 exposed to the front side of the housing 110. The terminal portion of the wire W that is connected to the terminal 101 is housed in the terminal accommodating chamber 111 of the housing 110. The wire W is lead outside from the rear of the terminal accommodating chamber 111.

An O-ring 130 is disposed between the inner face of the terminal accommodating chamber 111 of the housing 110 and the terminal 101. A seal ring 131 is disposed between the inner face of the terminal accommodating chamber 111 of the housing 110 and the terminal portion of the wire W. A unit packing 132 is provided on the attaching face of the housing 110 so as to enclose the outer circumference of the terminal 101. The shield shell 120 is fitted on the outer circumference of the housing 110. The shield shell 120 is provided with a mounting hole 121. The connector 100 is fixed to the attachment member 140 by inserting the front end portion of the housing 110 in a connector insertion aperture 141 of the attachment member 140, inserting a fastening screw (not shown) in the mounting hole 121, and screwing the fastening screw into the attachment member 140.

When the connector 100 is fixed to the attachment member 140, the unit packing 132 is compressively deformed by the fastening force of the fastening screw to be in tight contact with the attachment member 140. The unit packing 132 provides a seal between the housing 110 and the attachment member 140.

### SUMMARY OF THE INVENTION

However, when a unit packing 132 is provided separately from the housing 110, as in the conventional example, the number of parts and an man-hour for assembly disadvantageously increase. Specifically, a step of manufacturing the unit packing 132 and a step of fitting the manufactured unit packing 132 in the housing 110 are necessary. Moreover, a groove in which the unit packing 132 is fitted is required to be formed in the housing 110.

The present invention is made to solve the aforementioned problem. An object of the present invention is to provide a connector in which a seal is surely provided between a housing and an attachment member while the increase in, for example, the number of parts and a man-hour for assembly is minimized.

The connector according to the present invention includes a housing supporting a terminal, and a sealing portion sealing a space between the housing and an attachment member. The sealing portion is formed of a water-swellable sealing material provided on a face of the housing opposing the attachment member.

The housing may be formed of an insulating resin by overmolding the terminal and a wire. Moreover, the housing may be formed of an insulating resin by overmolding a shield shell with the terminal and the wire.

According to the present invention, a sealing portion can be provided by arranging a water-swellable sealing material on a face of a housing. The sealing portion can be provided while the increase in, for example, the number of parts and assembly steps is minimized. The sealing portion formed of a water-swellable sealing material makes tight contact with an attachment member to seal between the housing and the attachment member. In a case when water intrudes between the sealing portion and the attachment member, the sealing portion swells by absorbing water to plug the gap through which water intrudes, thereby preventing further intrusion of water. Accordingly, a seal can surely be provided between the housing and the attachment member while the increase in, for example, the number of parts and a man-hour for assembly is minimized.

### BRIEF DESCRIPTION OF DRAWINGS

FIG. 1A is a perspective view of a connector according to a conventional example;

FIG. 1B is a sectional view of the connector according to the conventional example;

FIG. 2 is a perspective view of a high-pressure connector illustrating one embodiment of the present invention.

FIG. 3A is a sectional view of the high-pressure connector illustrating one embodiment of the present invention;

FIG. 3B is an enlarged view of an essential portion including the sealing portion and the vicinity thereof illustrated in FIG. 3A according to one embodiment of the present invention;

FIG. 4A is a perspective view illustrating a step of assembling the high-pressure connector according to one embodiment of the present invention;

FIG. 4B is a perspective view illustrating a step of assembling the high-pressure connector according to one embodiment of the present invention;

FIG. 5A is a perspective view illustrating a step of assembling the high-pressure connector according to one embodiment of the present invention; and

FIG. 5B is a perspective view illustrating a step of assembling the high-pressure connector according to one embodiment of the present invention.

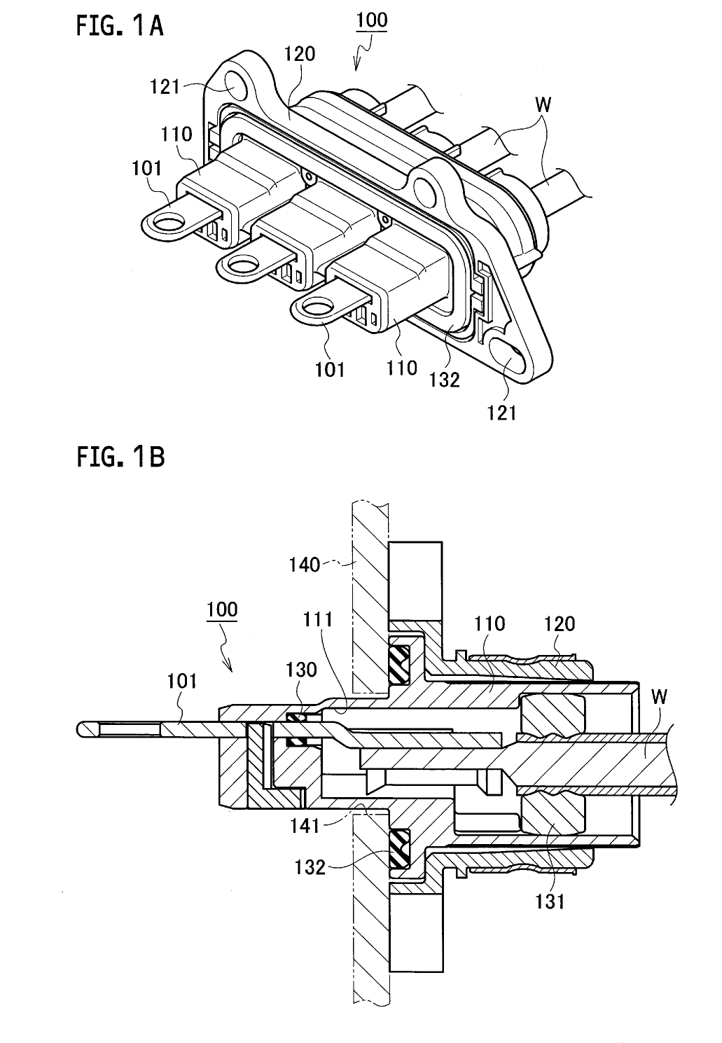

### DETAILED DESCRIPTION

An embodiment of the present invention is described in detail with reference to drawings.

In this specification, it must be noted that drawings are schematic views, and constitutions of devices and systems are different from constitutions of an actual device. Accordingly, the specific constitutions should be determined by taking into account the description made hereinafter. Further, it is also needless to say that the respective drawings include portions having different constitutions.

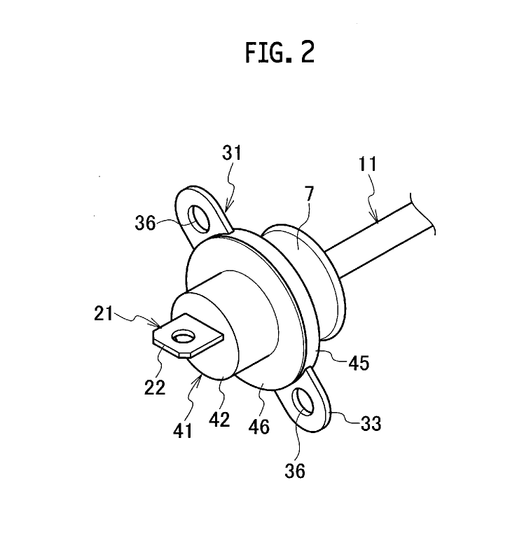

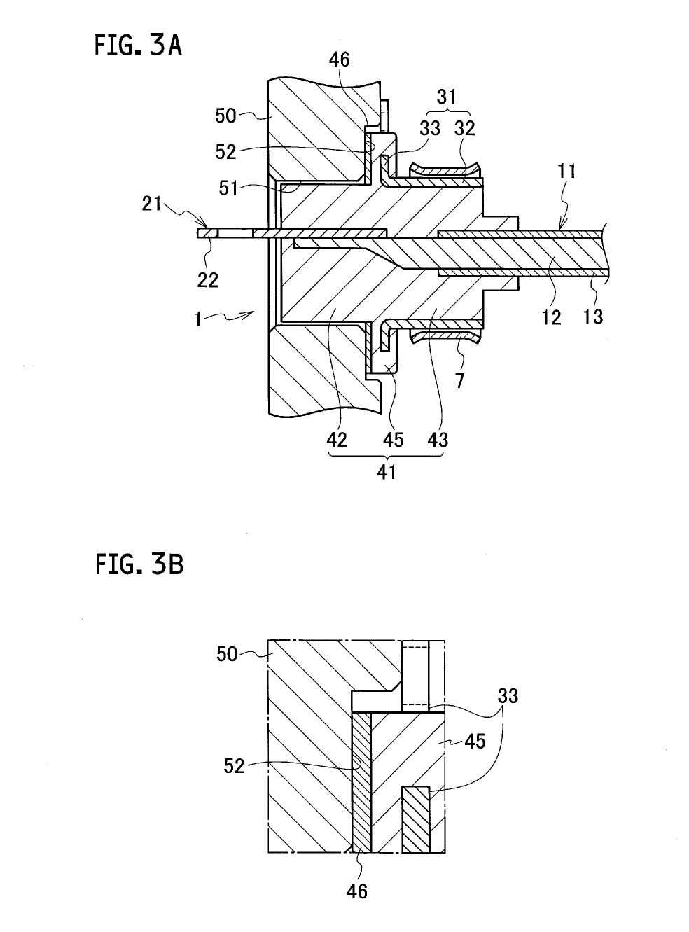

FIGS. 2 to 5B illustrate one embodiment of the present invention. As illustrated in FIGS. 2 to 3B, a high-pressure connector 1 is a connector directly attached to a cover casing 50 that serves as an attachment member of an inverter of an electric vehicle. The cover casing 50 is formed of a shield member that shields against electromagnetic waves. The cover casing 50 is provided with a connector insertion aperture 51 that penetrates through the inside of the cover casing 50 and a seal-accommodating recess 52 that encircles the entire circumference of the connector insertion aperture 51.

The high-pressure connector 1 includes a terminal 21 connected to a wire 11, a shield shell 31, and an integrated housing 41 serving as a housing.

The wire 11 is a shield wire. Specifically, the wire 11 is configured with a conductor 12 and a covering layer 13 that includes a shield layer (not shown) and covers the outer circumference of the conductor 12. The conductor 12 is exposed at a terminal of the wire 11. The exposed portion of the conductor 12 and the terminal 21 are connected to each other by, for example, welding. At a terminal of the wire 11, the covering layer 13 is folded outward and thereby the shield layer (not shown) is exposed, which is not illustrated in the drawing.

The terminal 21 serves as a part for providing electricity. A distal end portion 22 of the terminal 21 is exposed outside the integrated housing 41. The exposed distal end portion 22 protrudes inside the cover casing 50 through the connector insertion aperture 51 and is connected to a terminal of a target device, such as an inverter.

A shield shell 31 is formed of a conductive metal to shield against electromagnetic waves. The shield shell 31 includes a cylindrical sleeve portion 32 and a securing flange portion 33 that projects outward at the front end of the sleeve 32. The sleeve portion 32 is arranged so as to cover the outer circumference of the terminal portion of the wire 11. The securing flange portion 33 is provided with a plurality of securing holes 36. A fastening screw (not shown) is inserted through the securing hole 36 and fastened to the cover casing 50. The high-pressure connector 1 is thereby fixed to the cover casing 50. An end of a shield member (e.g., braided wire) covers the external face of the sleeve portion 32, and on the end of the shield member (e.g., braided wire), a swaging ring 7 is fixed by swaging. The other end of the shield member (e.g., braided wire) is securely connected to the shield layer at a terminal portion of the wire 11. That is, the conductor 12 exposed at the terminal of the wire 11 and the terminal 21 connected to the conductor 12 are shielded by the shield member (e.g., braided wire), the shield shell 31, and the cover casing 50.

The integrated housing 41 is formed by overmolding an insulating resin on the terminal 21, the wire 11, and the shield shell 31. The insulating resin forming the integrated housing 41 is filled without a space around the outer circumference of the terminal 21 except the distal end portion, around the outer circumference of the terminal portion of the wire 11, inside the inner circumference of the sleeve portion 32 of the shield shell 31, and around the root portion of the securing flange portion 33 of the shield shell 31. In this manner, the integrated housing 41 fixes together the terminal 21, the terminal portion of the wire 11, and the shield shell 31.

By the integrated housing 41 being filled around the outer circumference of the terminal 21 and the wire 11 without a space, waterproof is provided between the integrated housing 41 and the terminal 21 as well as between the integrated housing 41 and the wire 11. The integrated housing 41 provides insulation between parts (for example, between the terminal 21 and the shield shell 31).

The integrated housing 41 is formed of a resin material having a hardness equal to or higher than a rubber used for a sealing member (for example, acrylic) but equal to or lower than a typical resin material of a housing, for example, polybutylene terephthalate (PBT), so that the shield shell 31 functions to suppress external deformation (to increase stiffness) of the integrated housing 41. An elastomer-based resin material is preferably selected. As such a resin material, a material containing an adhesive including a hydroxyl group (OH group), which creates hydrogen bonding with metal, to a base elastomer of styrene-base, olefin-base, vinyl-chloride-base, polyester-base, polyurethane-base, or nylon-base is preferably used.

The integrated housing 41 is configured with a column-shaped front housing 42 that covers the outer circumference of the terminal 21, a column-shaped rear housing 43 that is arranged in the sleeve portion 32 of the shield shell 31, and an annular brim housing 45 that covers the root portion of the securing flange portion 33 of the shield shell 31. The front housing 42 is arranged in the connector insertion aperture 51 of the cover casing 50.

The brim housing 45 covering the front face of the securing flange portion 33 overhangs over the edge of the securing flange portion 33 to also cover the rear face of the securing flange portion 33. This configuration further firmly fixes together the integrated housing 41 and the shield shell 31, and also enhances the function of the shield shell 31 to suppress deformation of the integrated housing 41. By further enhancing the suppression of deformation of the brim housing 45, a material having much lower stiffness can be selected as the resin material of the integrated housing 41.

An annular sealing portion 46 is provided on the front face of the brim housing 45, that is, the face of the integrated housing 41 opposing the cover casing 50 and encircling the entire circumference of the front housing 42 (the terminal 21). The sealing portion 46 is formed of a water-swellable sealing material (hydrophilic coating) that swells by absorbing water. The water-swellable sealing material includes, for example, hyaluronic acid. As illustrated in FIGS. 3A and 3B, the sealing portion 46 is in tight contact with the seal-accommodating recess 52 by a force fastening the cover casing 50.

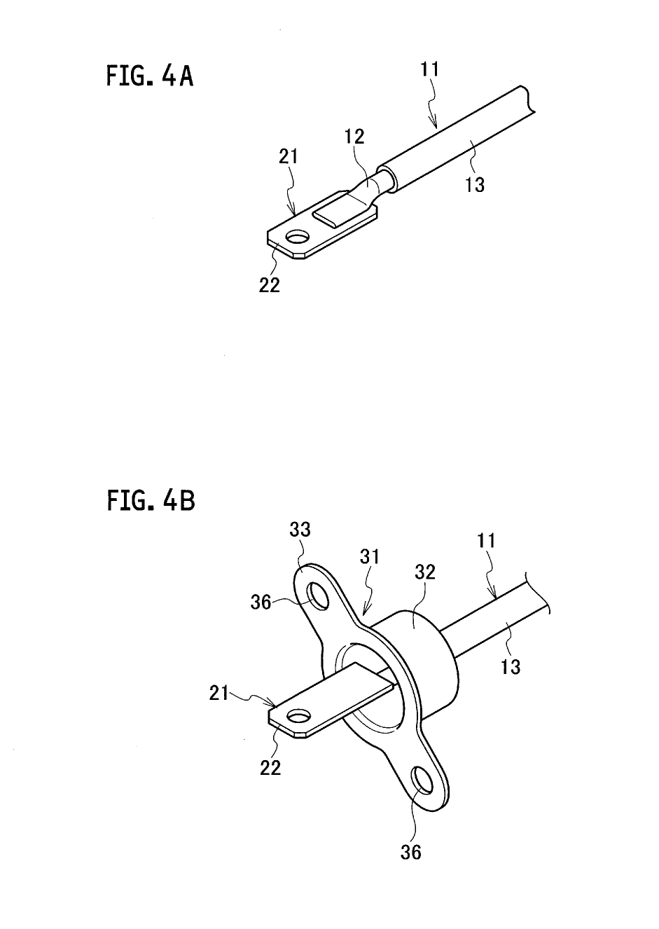

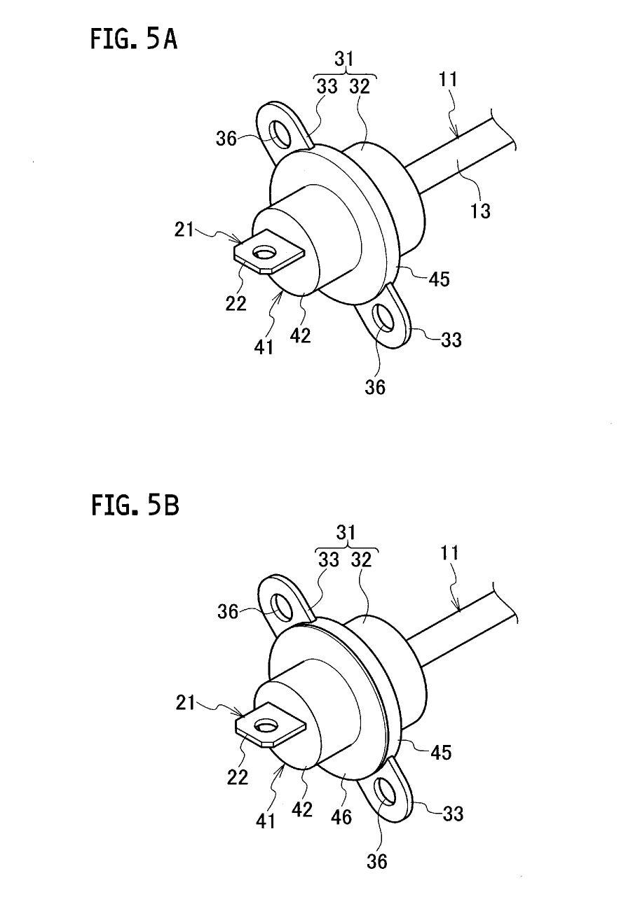

A procedure of assembling the high-pressure connector 1 will now be described referring to FIGS. 4A to 5B. As illustrated in FIG. 4A, the terminal 21 is connected to a terminal of the wire 11. As illustrated in FIG. 4B, the wire 11 and the terminal 21 are inserted in the shield shell 31, and the wire 11, the terminal 21, and the shield shell 31 are set at a predetermined position in a die (not shown). An elastomer-based resin material is injected in the die (not shown), in which the wire 11, the terminal 21, and the shield shell 31 are disposed as insert parts, to form the integrated housing 41 by overmolding. In this manner, a molded part illustrated in FIG. 5A is manufactured.

Then, as illustrated in FIG. 5B, the sealing portion 46 is formed by applying a water-swellable sealing material on the front face of the brim housing 45 of the integrated housing 41.

Finally, the terminal of the shield member (e.g., braided wire) covers the rear housing 43 of the shield shell 31, the swaging ring 7 covers the terminal of the shield member (e.g., braided wire), and the swaging ring 7 is swaged to securely connect the shield member (e.g., braided wire). The procedure is thus completed (see FIG. 2).

A procedure of attaching the high-pressure connector 1 to the cover casing 50 will now be described. The front housing 42 of the high-pressure connector 1 is inserted from the external in the connector insertion aperture 51 of the cover casing 50. The terminal 21 thereby projects inside the cover casing 50 and the sealing portion 46 of the integrated housing 41 is arranged in the seal-accommodating recess 52. Then, the fastening screw (not shown) inserted through the securing hole 36 of the shield shell 31 is screwed into the cover casing 50 to fasten the high-pressure connector 1 to the cover casing 50. By this fastening, a compressive force acts on the sealing portion 46 to cause the sealing portion 46 to make tight contact with the cover casing 50, as illustrated in FIG. 3B.

As described above, the integrated housing 41 of the high-pressure connector 1 is provided with the sealing portion 46 formed of a water-swellable sealing material. The water-swellable sealing material can easily be applied and formed on the integrated housing 41. Thus, the sealing portion 46 can be provided while the increase in the number of parts and assembly steps is minimized. The sealing portion 46 formed of a water-swellable sealing material makes tight contact with the cover casing 50 to provide a seal between the integrated housing 41 and the cover casing 50. In a case when water intrudes between the sealing portion 46 and the cover casing 50, the sealing portion 46 swells by absorbing water to plug the gap through which water intrudes, thereby preventing further intrusion of water. Accordingly, a seal can surely be provided between the integrated housing 41 and the cover casing 50 while the increase in, for example, the number of parts and a man-hour for assembly is minimized.

The integrated housing 41 is formed by overmolding an insulating resin material on the terminal 21 and the terminal portion of the wire 11. Therefore, the integrated housing 41 has a function of supporting parts accommodated therein as well as a function of providing waterproof between the integrated housing 41 and supported parts (the terminal 21 and the wire 11). These functions contribute to reduction in the number of parts of the high-pressure connector 1 and reduction in occupied spaces, and consequently achieve downsizing of the high-pressure connector 1.

The integrated housing 41 is formed by overmolding the insulating resin material on the shield shell 31 together with the terminal 21 and the terminal portion of the wire 11. Thus, the shield shell 31 serves as a member that increases stiffness of the integrated housing 41. Therefore, the integrated housing 41 is formed of a material having a lower stiffness than the conventional example as described above, in other words, formed of an elastically deformable material. Since the brim housing 45 of the integrated housing 41 compressively deforms by the force for fastening the high-pressure connector 1 to the cover casing 50, the sealing portion 46 deforms to fit against the irregularities on the attaching face. This improves sealability of the sealing portion 46.

Since the integrated housing 41 is overmolded on the shield shell 31, the brim housing 45 of the integrated housing 41 is in tight contact, without a gap, with the entire face of the securing flange portion 33 of the shield shell 31. Therefore, the fastening force of the fastening member is further effectively transmitted from the securing flange portion 33 to the brim housing 45, thereby improving sealability. In contrast, when the shield shell 31 is fitted on the integrated housing 41 that is formed by overmolding an insulating resin only on the terminal 21 and the wire 11, it is highly possible that the brim housing 45 of the integrated housing 41 and the face of the securing flange portion 33 of the shield shell 31 do not make tight contact with each other and therefore create a gap. If there is a gap between the brim housing 45 of the integrated housing 41 and the face of the securing flange portion 33 of the shield shell 31, the fastening force of the fastening member is not effectively transmitted from the securing flange portion 33 to the brim housing 45, and sealability is deteriorated.

Since the integrated housing 41 is overmolded on the shield shell 31, damages to the integrated housing 41 during assembly to the cover casing 50 as well as during steps before assembly (for example, during coating and transportation) can be prevented.

In the embodiment, the integrated housing 41 is formed by overmolding an insulating resin material on the terminal 21, the terminal portion of the wire 11, and the shield shell 31. Alternatively, the integrated housing 41 may be formed by overmolding an insulating resin material on the terminal 21 and the terminal portion of the wire 11, and then fitting the shield shell 31 on the outer circumference of the integrated housing 41. The rigidity of the integrated housing 41 can also be increased by fitting the shield shell 31 on the integrated housing 41 in the later step as described above, so that the integrated housing 41 can be formed by a resin material having a lower stiffness than a typical resin material for a housing (for example, PBT). The sealing portion 46 formed of a water-swellable sealing material makes tight contact with the cover casing 50 to seal between the integrated housing 41 and the cover casing 50.

Although the embodiment of the present invention has been described heretofore, the embodiment is merely exemplified for facilitating the understanding of the present invention, and the present invention is not limited to the embodiment. The technical scope of the present invention may include not only the specific technical matters disclosed in the above-described embodiment but also various modifications, changes, and alternative techniques easily derived from the above-described specific technical matters.

What is claimed is:

1. A connector comprising:
a housing supporting a terminal; and
a sealing portion sealing a space between the housing and an attachment member, wherein
the sealing portion is formed of a water-swellable sealing material provided on a face of the housing opposing the attachment member.

2. The connector according to claim 1, wherein
the housing is formed of an insulating resin by overmolding the terminal and a wire.

3. The connector according to claim 2, wherein
the housing is formed of an insulating resin by overmolding a shield shell with the terminal and the wire.
